(19) United States
(12) Patent Application Publication
(10) Pub. No.: US 2010/0010788 A1
(43) Pub. Date: Jan. 14, 2010

(54) METHOD OF CONSTRUCTING A METAMODEL FOR SIMULATING TECHNICAL DATA

(75) Inventor: Francois De Crecy, Seyssins (FR)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Commissariat A L'Energie Atomique

(21) Appl. No.: 12/497,935

(22) Filed: Jul. 6, 2009

(30) Foreign Application Priority Data
Jul. 8, 2008 (FR) 08 03874

(51) Int. Cl. G06F 17/10

(52) U.S. Cl. 703/2

(57) ABSTRACT

The invention relates to a method of interpolating technical data from simulations used to construct a training base comprising technical data vectors Xᵢ, for i varying from 1 to n, each vector presenting components xᵢ^{(k)}, for k varying from 1 to d, wherein the metamodel is a multidimensional pseudo-cubic thin plate type interpolation or quasi-interpolation spline having an analytic function ƒ(X):

$$f ( X ) = {\sum }_{i = 1}^{n} {λ}_{i} {‖ X - {X}_{i} ‖}^{3} + {\sum }_{k = 1}^{d} {α}_{k} {x}^{( k )} + {α}_{o}$$

$${‖ X - {X}_{i} ‖}^{2} = {\sum }_{k = 1}^{d} {{dil}_{k}^{2} ( \frac{{x}^{( k )} - {x}_{i}^{( k )}}{{σ}_{k}} )}^{2}$$

σₖ designating the standard deviation of the k^{th} components Xᵢ^{(k)} of the vectors Xᵢ and dilₖ designating the scale expansion associated with said k^{th} component;
λᵢ and αₖ being the solutions of a symmetrical linear system of dimension (n+d+1)²:

$${\sum }_{j = 1}^{n} {λ}_{j} \cdot {‖ {X}_{j} - {X}_{i} ‖}^{3} + \frac{{λ}_{i}}{ρ {ω}_{i}} + {\sum }_{k = 1}^{d} {α}_{k} \cdot {x}_{i}^{( k )} + {α}_{o} = {y}_{i}$$

for iε{1, 2, 3, . . . , n}

$${\sum }_{j = 1}^{n} {λ}_{j} \cdot {x}_{j}^{( k )} = 0$$

for kε{1, 2, 3, . . . , d}

$${\sum }_{j = 1}^{n} {λ}_{j} = 0$$

yᵢ designating the value of the response for the i^{th} simulation for the parameter value Xᵢ.

### FIELD OF THE INVENTION

The invention relates to providing assistance in analyzing technical data obtained by a technical, scientific, or engineering simulation method. The invention can thus relate to a very broad range of applications in numerous technical and scientific sectors, of which the following may be mentioned by way of example: microelectronics and micro- and nano-technologies (e.g. using technology computer aided design (TCAD) software, or simulation program with integrated circuit emphasis (SPICE) software), automobile, aviation, or space manufacture, building and public works, chemistry, mining, oil, and gas extraction, energy, the agrifood business, transport, finance, and digitally processing audio and/or video data.

### BACKGROUND OF THE INVENTION

In all of those domains, the person skilled in the art often seeks to understand or to visualize a phenomenon, or to optimize a part, a device, or a method, or to study sensitivity, variability, or reverse modeling, or to perform statistical or yield studies, or to create programs that simulate certain results within a fixed range of parameters.

To achieve this purpose, the person skilled in the art often has technical or scientific or engineering software available that enables the device, phenomenon, or concept under study to be simulated, and more particularly methods that are characterized by the following facts:
the person skilled in the art describes the device or phenomenon or concept under study in a language or with data sets using specific methodology. For this purpose, use is made of some number of “parameters”, i.e. numerical magnitudes, that enable the device or phenomenon or concept under study to be described (e.g. the shape of a device, the physical properties of materials, or the characteristics or portions or subassemblies of a device), or else that condition the implementation of a method (e.g. meshing, algorithmic or numerical parameters or selections). These “parameters” are selected by the person skilled in the art over some possible range.
The results are characterized by one or (more generally) more numerical “responses” that inform the person skilled in the art about the device or part or method or phenomenon or concept under study.
The method is deterministic, i.e. if the person skilled in the art uses the same method several times over with the same parameters on the same computer, then the same numerical “responses” will be obtained each time.

Known methods for technical or scientific or engineering simulation are often rather expensive, i.e. they require a large amount of processor (CPU) time and/or memory resources and/or archiving space. This implies that it is often difficult or impossible to implement the simulation for a large number of cases, e.g. several thousands or several tens of thousands or even hundreds of thousands or millions of cases, each case being defined by the values of the various parameters. Unfortunately, it is often necessary for the person skilled in the art to be capable of estimating what would be the responses for a large number of cases. It is therefore necessary to have means available for making such estimates.

To achieve this purpose (which is often understanding or visualizing a phenomenon, or optimizing a device or a method, or performing sensitivity, variability, or reverse modeling studies, or performing statistical or yield studies, or creating programs that simulate certain results in a fixed range of parameters), it is known to construct so-called “metamodels”.

A metamodel is defined herein as an analytic function that should be capable of being calculated fast by a computer, that gives a response, and that depends on a plurality of numerical parameters. Because the metamodel can be calculated very quickly, it replaces the full software in numerous applications, e.g. visualizing phenomena, optimizing, studying sensitivity, variability, or reverse modeling, statistical or yield studies, etc. . . . .

Such a metamodel is constructed from a certain number of simulations for which the parameters vary over a certain range. It is recommended to select simulations using digital simulation plane techniques, e.g. as described by Thomas J. Santner, Brian J. Williams, and William I. Notz in “Design and analysis of computer experiments”, Springer Series in Statistics, 2003.

The term “training base” is used to designate such a set of simulations carried out using the method and serving as a basis for building the metamodel. Typically this training base contains several tens to several hundreds or thousands of simulations represented by training vectors, but there is no harm in the base having a greater or smaller number thereof.

Given that the method is assumed to be deterministic, responses are entirely reproducible, and it is most preferable for the metamodel, when applied to one of the points in the training base, to return either exactly the same value as the response obtained by the software at said point, or else a value that is very close, i.e. the metamodel could either be an “interpolator” or a “quasi-interpolator”. An interpolator is a metamodel that passes exactly through all of the training points, whereas a quasi-interpolator is a metamodel that passes very close to all of the training points.

The term “very close to all of the points in the training base” should be understood as meaning that the residual variance must be small compared with the total variance, for example less 0.01 times the total variance, or better, for example, less than 0.001 times the total variance, or better still, for example, less than 0.0001 times the total variance.

The residual variance is defined herein as follows (in highly conventional manner) by:

$$Var\_resid = {\sum }_{j = 1}^{n} {ω}_{j} \cdot {( {R}_{simulation , j} - {R}_{metamodel} ( {X}_{j} ) )}^{2}$$

and the total variance is defined herein (in conventional manner) by:

$$Var\_total = {\sum }_{j = 1}^{n} {ω}_{j} \cdot {( {R}_{simulation , j} - < {R}_{simulation} > )}^{2}$$

The ωⱼ are weights that are all positive or zero (by default, if there are no predefined weights, all of the weights ωⱼ are taken as being equal to 1). n is the number of simulations in the training base. Xⱼ is the vector representing the set of parameters for the j^{th} simulation, R_{simulation,j} is the value of the response for the j^{th} simulation, R_{metamodel}(Xⱼ) is the metamodel associated with this response. <Rₛᵢₘᵤₗₐₜᵢₒₙ> is the mean weighted by the weights ωⱼ of all of the simulations in the training base.

A first known way of constructing the metamodel is to look for it in the form of a polynomial depending on various parameters. Under such circumstances, the metamodel is often referred to as a “response surface”, even though this term sometimes covers a greater set of metamodels, according to some authors. For example, the response R represented by a polynomial of total degree q depending on p variables x₁, x₂, . . . , xₖ, . . . , x_{d} is written as follows:

R=Σαᵢ_{₁}ᵢ_{₂} _{. . . i}_{ₖ} _{. . . i}_{_{d}}·x₁ⁱ^{ᵢ}·x₂ⁱ^{₂}· . . . ·xₖⁱ^{ₖ}· . . . ·

with, for all iₖ, 0≦iₖ≦q, and the total degree is q, i.e. the coefficients:

αᵢ_{₁}ᵢ_{₂} _{. . . i}_{ₖ} _{. . . i}_{d}

are zero if the sum i₁+i₂+ . . . +iₖ+ . . . +i_{d} is greater than q.

The coefficients:

αᵢ_{₁}ᵢ_{₂} _{. . . i}_{ₖ} _{. . . i}_{d}

define the polynomial. In order to determine them, the most conventional method is to perform a least squares regression. This amounts to minimizing the sum S of the (optionally weighted) squares of the differences relative to the response as genuinely simulated (obtained from the scientific or technical software), i.e. the residual variance:

$$S = {\sum }_{j = 1}^{n} {ω}_{j} \cdot {( {R}_{simulation , j} - {R}_{metamodel} ( {X}_{j} ) )}^{2}$$

The weights ωⱼ are all positive or zero. Xⱼ is the vector representing the set of parameters for the j^{th} simulation, R_{simulation,j} is the value of the response for the j^{th} simulation, R_{metamodel} is the metamodel associated with said response.

Details concerning least squares regressions and the method used for determining the numerical values of the coefficients:

αᵢ_{₁}ᵢ_{₂} _{. . . i}_{ₖ} _{. . . i}_{d}

are known to the person skilled in the art and are described for example in G. E. P. Box and N. R. Draper, “Empirical model-building and response surfaces”, Wiley series in Probability and Mathematical Statistics, 1987, or indeed W.H. Press, S. A. Teukolsky, W. T. Vetterling, and B. P. Flannery, “Numerical recipes, the art of scientific computing”, third edition, Cambridge University Press, 2007.

The main drawback of building a metamodel using polynomials lies in the following dilemma:
either the metamodel is required to be an interpolator, in which case it is necessary to have a polynomial of total degree that is high, often having a total number of non-zero coefficients:

αᵢ_{₁}ᵢ_{₂} _{. . . i}_{ₖ} _{. . . i}_{d}

that is equal to (or hardly any less than) the total number of simulations in the training base. Under such circumstances, the person skilled in the art knows that the behavior of the polynomial is highly chaotic in interpolation and even worse in extrapolation, making such interpolations and extrapolations unreliable; and
or else a more limited number of non-zero coefficients are imposed on the polynomial in order to ensure that its behavior in interpolation and extrapolation presents little chaos. The person skilled in the art knows several ways of selecting these coefficients and determining their values: these ways are often based on analyzing variance, and by way of example they are described in the above-mentioned work by G. E. P. Box and N. Draper. However, this technique presents several major drawbacks: the statistical theoretical bases rely on a model in which the response obtained can be considered as being the result of taking samples from a random function, and that does not apply here. In addition, the resulting metamodel is neither an interpolator nor a quasi-interpolator, and as mentioned above, it is preferable that it should be.

To mitigate those drawbacks, the person skilled in the art frequently makes use of various kriging methods for constructing a metamodel. A good introduction to such kriging methods (initially used in geostatistics) is to be found for example in the above-mentioned work by Thomas J. Santner et al. Kriging is a spatial interpolation method that is sometimes considered as being the most accurate from a statistical point of view, that makes it possible to achieve a linear estimate that is based on mathematical expectation and also on the variance of the spatialized data item. It involves the correlation function between the value of the function at points Xᵢ and Xⱼ, where Xᵢ and Xⱼ each represents a set of numerical values for d parameters, thus, for example, each represents a simulation by the software. Mathematically, they are elements of [symbol] ^{d}, i.e. vectors made up of d real terms ( [symbol] being the set of real numbers), and the basic assumption is that this correlation function depends only on a “distance” (in the mathematical sense of the word) between the points Xᵢ and Xⱼ, written ∥Xᵢ−Xⱼ∥, which distance may be defined for example by:

$$‖ {X}_{i} - {X}_{j} ‖ = \sqrt{{\sum }_{k = 1}^{d} {( \frac{{x}_{i}^{( k )} - {x}_{j}^{( k )}}{{θ}_{k}} )}^{2}}$$

where xᵢ^{(k)} is the k^{th} component of Xᵢ (the k^{th} parameter) The magnitudes θₖ are often referred to as the “ranges” of the parameter k. They must be non-zero and they are usually selected to be positive.

A conventional (but not unique, there are many others) example of a correlation function r(X, Xⱼ) between X and Xⱼ is as follows:

$$r ( X , {X}_{j} ) = exp ( - {‖ X - {X}_{j} ‖}^{2} ) = exp ( - {\sum }_{k = 1}^{d} {( \frac{{x}^{( k )} - {x}_{j}^{( k )}}{{θ}_{k}} )}^{2} )$$

The metamodel given kriging has the form:

$$f ( X ) = {\sum }_{j = 1}^{p} {β}_{j} {g}_{j} ( X ) + {\sum }_{i = 1}^{n} {λ}_{i} r ( X , {X}_{i} )$$

where:
X represents an arbitrary current point, i.e. a set of numerical values for the d parameters;
Xᵢ for i varying from 1 to n are the vectors representing the n points (or software simulations) in the training base, each of these points being a set of d numerical values;
the p functions gⱼ(X) are selected a priori and are referred to as “trend terms”;
r(X, Xᵢ) is the correlation function between X and Xᵢ; and
the p coefficients βⱼ and the n coefficients λᵢ are calculated from the responses and the parameters of the training base.

In a kriging variant known as ordinary kriging, p=1 (only one trend term) and g₁(X)=1 (this term is constant and equal to unity).

In universal kriging, which is another variant of kriging, there is a plurality of trend terms. A conventional choice for universal kriging is to take p=d+1 and to select the d linear effects:

gⱼ(X)=x^{(j)}

and one constant term g_{d+1}(X)=1.

Another conventional choice for universal kriging is to select the p most influential terms as determined by an analysis of variance performed on the training base using the various monomials taken from a polynomial of total degree 2 or 3 as the candidate functions.

The way of obtaining the p coefficients βᵢ and the n coefficients λᵢ is known to the person skilled in the art and is described in numerous works, for example in the work by Thomas J. Santner et al. It requires linear systems of size n×n to be solved with a plurality of second members. That document also describes statistical methods for determining the optimum ranges θₖ, but they are often iterative methods that require rather large quantities of calculation.

Kriging is a conventional method of constructing an interpolator. It is also possible (at the cost of considerable calculation) to use the intermediate kriging calculations to estimate a standard deviation at each point around the metamodel and on the basis of confidence intervals. The standard deviations are zero for the training points (the function is an interpolator) and they increase on going further away from the training points. FIG. 1 is a diagram showing this behavior for the one-dimensional case (d=1).

The way in which these standard deviations are obtained is known to the person skilled in the art. It is described in numerous works, for example in the above-mentioned work by Thomas J. Santner et al.

Nevertheless, kriging suffers from a certain number of drawbacks:
The n×n linear system to be solved is sometimes not very stable, making its solution impossible or very imprecise, in particular when n is relatively large (e.g. of the order of one thousand or more) and the points in the training base are not distributed regularly. To mitigate that drawback, it is possible to use what the person skilled in the art refers to as “nuggets” (which technique is described for example in the above-mentioned document by Thomas J. Santner et al.), but in so doing kriging loses it prime quality of being an interpolator.
Experience shows that the ability of kriging to reproduce well the behavior of the software over test points selected in the same domain as the training points but distinct therefrom can sometimes be disappointing, i.e. the root mean square error between values of the response predicted by the metamodel and the response values obtained by simulation with the software is found to be abnormally large under such circumstances.

### OBJECT AND SUMMARY OF THE INVENTION

The invention thus provides a method of interpolating technical data, the method comprising using a computer to construct a metamodel from simulations setting up a training base comprising technical data vectors Xᵢ, for i lying in the range 1 to n, each vector presenting components xᵢ^{(k)}, k varying from 1 to d, wherein the metamodel is a multidimensional pseudo-cubic thin plate type interpolation or quasi-interpolation spline having an analytic function ƒ(X):

$$f ( X ) = {\sum }_{i = 1}^{n} {λ}_{i} {‖ X - {X}_{i} ‖}^{3} + {\sum }_{k = 1}^{d} {α}_{k} {x}^{( k )} + {α}_{o}$$

$${‖ X - {X}_{i} ‖}^{2} = {\sum }_{k = 1}^{d} {{dil}_{k}^{2} ( \frac{{x}^{( k )} - {x}_{i}^{( k )}}{{σ}_{k}} )}^{2}$$

σₖ designating the standard deviation of the k^{th} components; and

dilₖ being a scale expansion optionally associated with said k^{th} component (dilₖ increasing with increasing non-linear effects associated with said parameter)

λᵢ and αₖ being the solutions of a symmetrical linear system of dimension (n+d+1)²:

$${\sum }_{j = 1}^{n} {λ}_{j} \cdot {‖ {X}_{j} - {X}_{i} ‖}^{3} + \frac{{λ}_{i}}{ρ {ω}_{i}} + {\sum }_{k = 1}^{d} {α}_{k} \cdot {x}_{i}^{( k )} + {α}_{o} = {y}_{i}$$

for iε{1, 2, 3, . . . , n}

$${\sum }_{j = 1}^{n} {λ}_{j} \cdot {x}_{j}^{( k )} = 0$$

for kε{1, 2, 3, . . . , d}

$${\sum }_{j = 1}^{n} {λ}_{j} = 0$$

yᵢ designating the value of the response for the i^{th} simulation for the parameter value Xᵢ, ωᵢ being a weight associated with the i^{th} simulation. If the simulations are not weighted, i.e. if they all have the same importance, then ωᵢ=1 for all i;

ρ is a smoothing parameter, which is infinite for an interpolation spline (true interpolation). Generally speaking, the greater the smoothing parameter, the smaller the residual variance. The smoothing parameter ρ is considered as being “large” if the metamodel obtained in this way is a quasi-interpolator. By way of example, ρ may be selected to lie in the range 10³ to 10¹², and more particularly in the range 10⁴ to 10¹⁰.

In order to determine the scale expansions dilₖ, the following operations may be performed:

a) starting from an initial estimate of the d scale expansions dilₖ;

b) randomly or pseudo-randomly partitioning the n simulation results Xᵢ into np disjoint portions (p≧1);

c) iterating over P portions with P≦np;

d) initializing a cross-validation variance to zero;

e) calculating a cross-validation variance from the scale expansion values dilₖ;

f) choosing new scale expansion values that minimize said cross-validation variance obtained during e); and

g) iterating from e) with said new scale expansion values; and

g′) optionally, between e) and f) or between f) and g) testing convergence with a convergence criterion, and if the criterion is satisfied, exiting the iterative process with the current scale expansion values.

Preferably, P<np and the portions are selected randomly.

In order to calculate a cross-validation variance, for p varying from 1 to P, step e) may comprise:

e₁) temporarily eliminating all of the simulation results in said portion;

e₂) determining the function ƒ(X) without these points;

e₃) using the function ƒ(X) solely for recalculating the predicted values over the n_{q} temporarily eliminated points;

e₄) incrementing the cross-validation variance by the sum of the squares of the differences between the predicted values for the temporarily eliminated points and the simulation values for the temporarily eliminated points, this sum being applied to all of the temporarily eliminated points; and

e₅) reintegrating the temporarily eliminated points.

The value of np may lie in the range 5 to 50 for example.

For n_{q} being the number of results in the q^{th} portion, n_{q} may be substantially the same for each portion, and in particular:

$${\sum }_{q = 1}^{np} {n}_{q} = n$$

More particularly, it is possible to have p=1, np=n, and n_{q}=1 for all q.

In a preferred variant, in order to calculate the scale expansions dilₖ, the method may comprise:

a′) starting from an initial estimate of all of the scale expansions, satisfying the condition

$${\prod }_{k = 1}^{d} {dil}_{k} = 1 ,$$

in particular dilₖ=1 for all k;

b′) constructing the multidimensional pseudo-cubic thin plate type spline function ƒ(X) with said scale expansions;

c′) calculating the d second derivatives of the multidimensional pseudo-cubic thin plate type spline function relative to the d parameters:

$$\frac{{\partial }^{2} f ( {X}_{i} )}{\partial {x}^{{( k )}^{2}}}$$

for k=1 to d, and doing this for each of the n points in the training base (i varying from 1 to n);

d′) for each of the d parameters, calculating the root mean square over all of the points in the training base, of the second derivatives calculated in step c′), this root mean square being defined by:

$$SQD 2 F ( k ) = \sqrt{\frac{{\sum }_{i = 1}^{n} {( \frac{{\partial }^{2} f ( {X}_{i} )}{\partial {x}^{{( k )}^{2}}} )}^{2}}{n}}$$

for k lying in the range 1 to d

e′) for this set of scale expansions, calculating a cross-validation variance or a generalized cross-validation variance;

f′) from the second iteration of the iterative process and if the variance is greater than that obtained at the preceding iteration, exiting the iterative process with the scale expansion values of the preceding iteration and retaining the multidimensional pseudo-cubic thin plate type spline function for these scale expansions of the preceding iteration;

g′) calculating the geometrical mean C of the above-defined quantities SQD2F(k) weighted by the square of σₖ:

$$C = {( {\prod }_{k = 1}^{d} {σ}_{k}^{2} SQD 2 F ( k ) )}^{1 / d}$$

h′) calculating new scale expansions, in particular using the following formula:

$${new\_dil}_{k} = {σ}_{k} \sqrt{\frac{SQD 2 F ( k )}{C}}$$

i′) optionally, testing the convergence of the iterative process, this may be done for example by testing the maximum of the absolute values of relative variations between dilₖ and new_dilₖ, i.e. by comparing the following quantity:

$${max}_{k = 1 to n} ( \frac{\vert {dil}_{k} - {new\_dil}_{k} \vert}{{dil}_{k}} )$$

with, for example, a predefined convergence threshold. If this quantity is less than the convergence threshold, then convergence is deemed to have been achieved and the iterative process is exited. The new scale expansions obtained in h′) are retained;

i₁′) (optionally) verifying the proper behavior of the iterative process, e.g. by verifying at least one condition, i.e. whether the number of iterations is less than a maximum allowed number of iterations, and/or whether the ratio:

max(new_dilₖ, k=1 to d)/min(new_dilₖ, k=1 to d) is less than another predefined threshold, and if a said condition is not satisfied, exiting the iterative process, where max and min designate the maximum and minimum values for the d parameters in the parentheses;

j′) updating the scale expansions, i.e. replacing dilₖ for k=1 to d with new_dilₖ for k=1 to d, and returning to step b′) for the next iteration, from these updated scale expansions.

In order to calculate the scale expansions, it is advantageous when the metamodel is a quasi-interpolator to use a generalized cross-validation variance GCV. For this purpose, said cross-validation variance may be a generalized variance GCV, with:

$$G C V = \frac{{\sum }_{i = 1}^{n} {{ω}_{i} ( f ( {X}_{i} ) - {y}_{i} )}^{2}}{{( n - trace ( {A}_{ρ} ) )}^{2}}$$

$$and$$

$${\sum }_{i = 1}^{n} {ω}_{i} = n$$

and trace (A_{ρ}) is the trace of the smoothing matrix A_{ρ} that causes the vector Y of the n responses yᵢ to change to the vector F of the n quasi-interpolated values f(Xᵢ): i.e.:

F=Aᵣ·Y

with

F=(f(X₁), f(X₂), . . . , f(Xᵢ), . . . , f(Xₙ))^{t}

and

Y=(y₁, y₂, . . . , yᵢ, . . . , yₙ)^{t}

the index t designating the transposed matrix, the spline being calculated with a smoothing parameter ρ that is not infinite, but that is such that the metamodel can be considered as being a quasi-interpolator.

The parameter trace(A_{ρ}) may be calculated in particular by using a Monte-Carlo method.

### BRIEF DESCRIPTION OF THE DRAWINGS

The invention can be better understood on reading the following description,

FIG. 1 showing the confidence intervals of a kriging method of the prior art for the one-dimensional case, i.e. there is only d=1 parameter, with this explanatory parameter plotted along the abscissa and with the value of the metamodel plotted up the ordinate, and

FIGS. 2 and 3 are flow charts corresponding to two methods of calculating scale expansions.

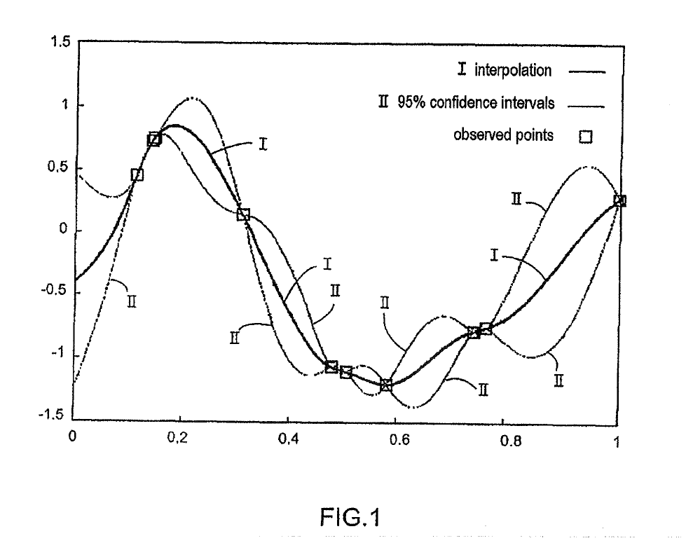

### MORE DETAILED DESCRIPTION

The idea on which the invention is based is thus to use as metamodels interpolation or quasi-interpolation splines that are multidimensional, pseudo-cubic, and of the thin plate type. Although known, these splines are relatively rarely used in the literature, and they form part of the family of multidimensional splines that are invariant in rotation, making use of radial base functions, being known to the person skilled in the art from the following document:
J. Duchon, “Splines minimizing rotation-invariant semi-norms in Sobolev space”, Lecture Notes in Mathematics, Vol. 571, pp. 85-100, 1977, and also from the proceedings of a conference “Constructive theory of functions of several variables”, held at Oberwolfach, Apr. 25-May 1, 1976, edited by W. Schemp and K. Zellers (Eds.), Berlin: Springer-Verlag, pp. 85-100.

The way in which a symmetrical linear system is solved is conventional, being very well known to the person skilled in the art, and described in numerous works, and programmed in numerous mathematical libraries or programs.

The families of multidimensional splines used in the context of the present invention have functions of [symbol] ^{d} in [symbol] , where d is the dimension of the space, i.e. the number of parameters.

In general, a smoothing spline is a function ƒ that minimizes a total energy, the sum of a bending energy plus a residual variance multiplied by the smoothing parameter ρ:

$${E}_{t} = {E}_{c} ( f ) + ρ \cdot {\sum }_{i = 1}^{n} {{ω}_{i} ( f ( {X}_{i} ) - {y}_{i} )}^{2}$$

where n is the number of points, yᵢ is the value of the response for the i^{th} simulation, and Xᵢ is the vector of explanatory variables, i.e. the values of the d parameters for the i^{th} simulation, and ωᵢ is the weight given to the i^{th} point or simulation.

Each spline family is characterized by the expression for its bending energy. For pseudo-cubic multidimensional splines of the “thin plate” type, the bending energy is, according to the above-mentioned document by J. Duchon, given by:

$${E}_{c} ( f ) = {\int }_{{R}^{d}} {\sum }_{k = 1}^{d} {\sum }_{p = 1}^{d} {[ Four ( \frac{{\partial }^{2} f}{\partial {t}_{k} \partial {t}_{p}} ) ( u ) ]}^{2} {‖ u ‖}^{d - 1} d {u}_{1} d {u}_{2} … d {u}_{d}$$

where d is the dimension of the explanatory variables space and Four is the Fourier transform in [symbol] ^{d}, the square of the Fourier transform being the square of the norm.

The least squares regression corresponds to the limiting case of ρ→0.

The interpolation spline corresponds to the limiting case of pρ→∞: the spline must pass through all of the points, i.e. the residual variance is zero, and the bending energy is minimized. An interpolation spline is a limiting case of a smoothing spline.

The quasi-interpolation spline corresponds to the case where the smoothing parameter ρ is large, i.e. the residual variant is small compared with the total variant of the yᵢ, i.e. the residual variance is, for example, less than 0.01 times the total variance, or better the residual variance is, for example, less than 0.001 times the total variance, or better still the residual variance is, for example, less than 0.0001 times the total variance.

The residual variance is defined here (in highly conventional manner) as follows:

$$Var\_resid = {\sum }_{j = 1}^{n} {ω}_{j} \cdot {( {y}_{j} - f ( {X}_{j} ) )}^{2}$$

and the total variance is defined herein (in conventional manner) as follows:

$$Var\_total = {\sum }_{j = 1}^{n} {ω}_{j} \cdot {( {y}_{j} - < y > )}^{2}$$

where <y> is the mean value of the n values yᵢ weighted by the weights ωᵢ.

The use of multidimensional pseudo-cubic thin plate type smoothing splines for analyzing experimental results is already known to the person skilled in the art, e.g. from the publication by F. DeCrecy, “Pseudo-cubic thin plate spline method for analyzing experimental data”, published in Nuclear Engineering and Design, Vol. 149, pp. 459-465 (1994).

The analytic form of a multidimensional pseudo-cubic thin plate type spline is as follows, regardless of whether it is an interpolation spline or a smoothing spline:

$$f ( X ) = {\sum }_{i = 1}^{n} {λ}_{i} {‖ X - {X}_{i} ‖}^{3} + {\sum }_{k = 1}^{d} {α}_{k} {x}^{( k )} + {α}_{o}$$

where x^{(k)} is the k^{th} component (or parameter) of X, Xᵢ is the vector of d parameter values for the i^{th} stimulation, and where the norm is defined by:

$${‖ X - {X}_{i} ‖}^{2} = {\sum }_{k = 1}^{d} {{dil}_{k}^{2} ( \frac{{x}^{( k )} - {x}_{i}^{( k )}}{{σ}_{k}} )}^{2}$$

σₖ being a positive characteristic magnitude associated with the k^{th} components of Xᵢ, e.g. the standard deviation of the values of the k^{th} components of the Xᵢ (i.e. of the values for the k^{th} parameter), and where dilₖ is the scale expansion associated with the k^{th} parameter. Where appropriate, these scale expansions represent the relative importance of the non-linear effects of the various parameters. They are generally selected to be positive. The greater their values, the greater the non-linear effects associated with the parameter. It is frequent and recommended, but not essential, to impose an additional condition on these scale expansions, for example:

$${\prod }_{k = 1}^{d} {dil}_{k} = 1$$

Such a spline is defined for all [symbol] ^{d}. On going away from the zone where there are points Xᵢ, it tends locally towards a hyperplane.

For each value of the smoothing parameter ρ and of the scale expansion dilₖ, the coefficients λⱼ and αₖ are solutions of a symmetrical linear system of dimension (n+d+1)×(n+d+1). This system is:

$${\sum }_{j = 1}^{n} {λ}_{j} \cdot {‖ {X}_{j} - {X}_{i} ‖}^{3} + \frac{{λ}_{i}}{ρ \cdot {ω}_{i}} + {\sum }_{k = 1}^{d} {α}_{k} \cdot {x}_{i}^{( k )} + {α}_{o} = {y}_{i}$$

for iε{1, 2, 3, . . . , n}

$${\sum }_{j = 1}^{n} {λ}_{j} \cdot {x}_{j}^{( k )} = 0$$

for kε{1, 2, 3, . . . , d}

$${\sum }_{j = 1}^{n} {λ}_{j} = 0$$

The person skilled in the art knows how to use a computer to solve this linear system. Numerous methods exist, and the most conventional methods are described in the above-mentioned document by W.H. Press et al.

Within this context, the notation is the same as that described above: in particular, the norm involves scale expansions. The yᵢ are the magnitudes to be smoothed or interpolated (measurement results or simulation responses: yᵢ is the value of the response for the i^{th} simulation) for the value Xᵢ of the parameters.

A quasi-interpolation smoothing spline is obtained when the smoothing parameter ρ is large enough to ensure that the metamodel is a quasi-interpolation.

With an interpolation spline, ρ=∞, and the system simplifies directly into:

$${\sum }_{j = 1}^{n} {λ}_{j} \cdot {‖ {X}_{j} - {X}_{i} ‖}^{3} + {\sum }_{k = 1}^{d} {α}_{k} \cdot {x}_{i}^{( k )} + {α}_{o} = {y}_{i}$$

for iε={1, 2, 3, . . . , n}

$${\sum }_{j = 1}^{n} {λ}_{j} \cdot {x}_{j}^{( k )} = 0$$

for kε{1, 2, 3, . . . , d}

$${\sum }_{j = 1}^{n} {λ}_{j} = 0$$

For an interpolation, the main diagonal of the matrix associated with this symmetrical linear system therefore contains only zeros.

It is recommended, where appropriate, to select scale expansions dilₖ associated with various parameters, if account is to be taken of non-linearity.

A first variant is to use a method of the simple “cross-validation” variance (CVV) type. Cross-validation techniques are conventional and are described in particular in the article by Ron Kohavi, “A study of cross-validation and bootstrap for accuracy estimation and model selection”, International Joint Conference on Artificial Intelligence ISCA, 1995.

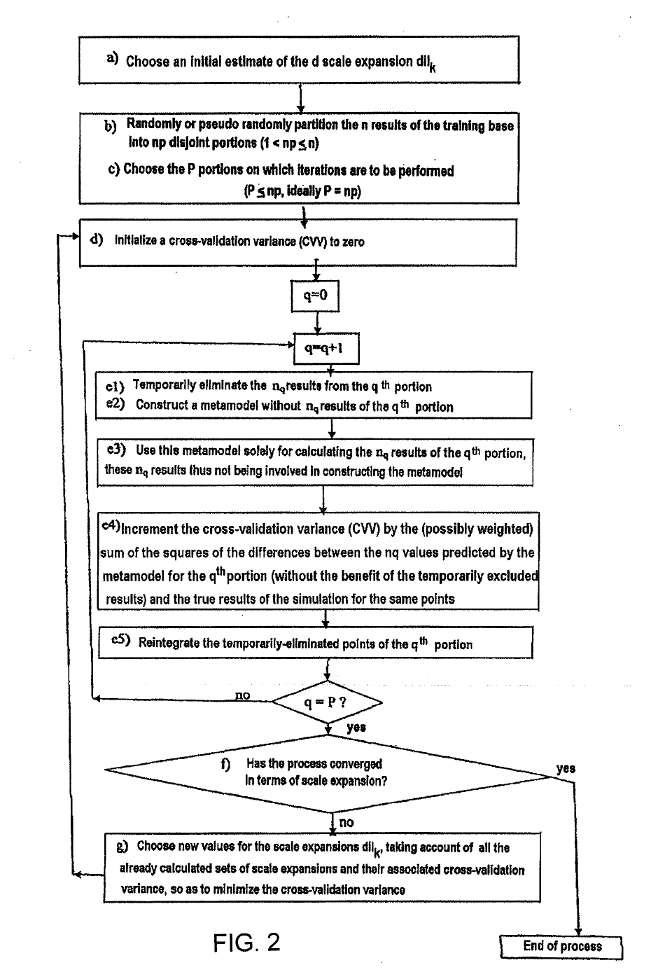

In outline, it comprises the following procedure (see FIG. 2):

1) Starting from an initial estimate of the d scale expansions dilₖ, kε{1, 2, 3, . . . , d}.

2) Partitioning all of the n simulation results of the training base in random or pseudo-random manner to obtain np disjoint portions. A conventional choice is to select np in the range 5 to 50. Let n_{q} be the number of results in the q^{th} portion. A conventional choice is to have the same order of magnitude n_{q} for all portions. A recommended choice is to have

$${\sum }_{q = 1}^{np} {n}_{q}$$

equal to n or close to n. If plenty of computation time is available, a choice that is recommended, reliable, and robust (but time consuming) is to take np=n and n_{q}=1, for all q.

3) Choosing P portions on which interactions are to be performed. It is preferable to have P=np, but that often leads to calculation that is very lengthy. Thus, it is sometimes preferable to take P<np. The portions that are selected are selected randomly.

4) Initialize cross-validation variance CVV as zero.

5) For q=1 to P: {iterating over the portions}.
a) Eliminating temporarily all of the n_{q} simulation results from this portion No. q, i.e. from the q^{th} portion of the partitioning mentioned in above step 2).
b) Determining the spline without these points.
c) Using this spline solely for recalculating the predicted values for the n_{q} temporarily eliminated points.
d) Incrementing the cross-validation variance CVV by the sum of the squares of the differences (possibly weighted by the weights ωᵢ) between the values predicted by the spline without the temporarily eliminated points and the values given by the true simulation, this sum being applied to all of the n_{q} points that have been temporarily eliminated.
e) Reintegrating the temporarily eliminated points.

6) Storing the value CVV of the variance associated with the scale expansions dilₖ used.

7) Choosing new scale expansion values in order to minimize the cross-validation variance CVV. There are numerous methods known to the person skilled in the art for selecting these new scale expansion values, e.g. the “Simplex” method or genetic algorithms or Powell's Direction Set Method. The Simplex method and Powell's method are described in the above-mentioned book by W.H. Press et al. Genetic algorithms are described in numerous works, for example the book by A. E. Eiben and J. E. Smith, “Introduction to evolutionary computing” 2003, Springer.

8) Testing convergence (e.g. small variation in the variance CVV or the scale expansions dilₖ). If convergence is not achieved, the method returns to step 4. This test can also be performed between steps 6 and 7.

Another difficulty comes from the fact that the various parameters may vary over ranges that are very different from one another, and this can give rise to problems for the stability of the (n+d+1)×(n+d+1) matrix associated with the linear system to be solved, if they are used directly without being transformed. That is why it is strongly recommended to work on non-dimensional parameters, e.g. centered parameters that have been reduced by the following formula:

$${x}^{( k ) +} = \frac{{x}^{( k )} - {m}_{k}}{{σ}_{k}}$$

where mₖ is the mean of the values for the k^{th} parameter and σₖ is a positive characteristic magnitude associated with the k^{th} parameter, e.g. the standard deviation of the values for the k^{th} parameter. It is this non-dimensionalization that is performed above in the definition used for the norm.

A difficulty can sometimes arise in that the (n+d+1)×(n+d+1) matrix associated with the linear system to be solved is poorly conditioned, even with reduced centered parameters. This can happen, for example, when the distribution of simulations in [symbol] ^{d} is very irregular, with a few simulations that are much closer together than the average. One way of solving this difficulty is to approximate the interpolation spline by a smoothing spline using a smoothing parameter ρ that is very large, e.g. lying in the range [10³ to 10¹⁰], if all of the parameters and responses have been centered and reduced. With large values for the smoothing parameter ρ, the smoothing spline is very close to the interpolation spline: the resulting metamodel is a “quasi-interpolator”.

A second variant for choosing scale expansions (solely when using a quasi-interpolator, and not a true interpolator) is to perform generalized cross-validation GCV. This other technique is based on the fact that a good approximation to the above-defined simple cross-validation variance CVV is GCV, referred to as generalized cross-validation variance and defined by:

$$GCV = \frac{{\sum }_{i = 1}^{n} {{ω}_{i} ( f ( {X}_{i} ) - {y}_{i} )}^{2}}{{( n - trace ( {A}_{ρ} ) )}^{2}}$$

where it is assumed that the mean of the weights ωᵢ is equal to 1, i.e.

$${\sum }_{i = 1}^{n} {ω}_{i} = n$$

and trace (A_{ρ}) is the trace of the smoothing matrix, the smoothing matrix A_{ρ} being the matrix that converts from the vector of n responses yᵢ to the n quasi-interpolated values f (Xᵢ):

F=A_{ρ}•Y

the sign • designating a matrix product with
F=(f(X₁), f(X₂), . . . , f(Xᵢ), . . . , f(Xₙ))^{t} and Y=(y₁, y₂, . . . , yᵢ, . . . , yₙ)^{t}

A good approximation for the trace of A_{ρ} and consequently for GCV can be found using Monte-Carlo method known to the person skilled in the art and described, for example in the document by D. A. Girard, “A fast “Monte-Carlo cross-validation” procedure for large least squares problems with noisy data”, Numerische Mathematik, Vol. 56, pp. 1-23, 1989. This method is much less expensive in calculation time than true cross-validation, but it is sometimes rather less robust and it does not apply to true interpolators.

In these first two variants, scale expansions are iterated in order to minimize CVV or GCV, as the case may be. The way in which these iterations are managed is well known to the person skilled in the art who seeks to minimize a function in a parameter space, and it is possible to use the conventional Simplex method or Powell's method (“Direction Set Method”).

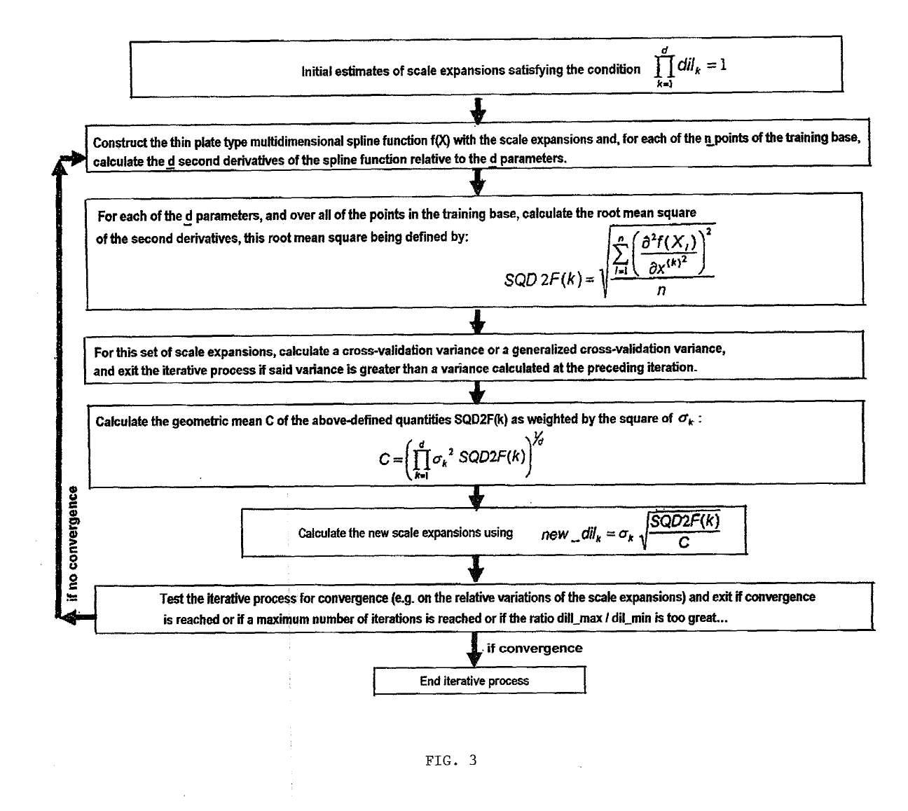

A preferred, third variant, shown in FIG. 3, consists in not seeking to minimize CVV or GCV over the entire possible domain of scale expansions, but only over a selected path. The main advantage of this other method is that is it much faster in central processor unit (CPU) calculation time for optimization results that are generally almost as good.

In order to understand this variant, use is made of intermediate variables u^{(k)} defined as follows:

$${u}^{( k )} = {x}^{( k )} \cdot \frac{{dil}_{k}}{{σ}_{k}}$$

With this variant u^{(k)}, the norm used in the definition of the multidimensional pseudo-cubic thin plate type spline function h(U) becomes the conventional Euclidean norm:

$$h ( U ) = {\sum }_{i = 1}^{n} {λ}_{i} {‖ U - {U}_{i} ‖}^{3} + {\sum }_{k = 1}^{d} {α}_{k} {u}^{( k )} + {α}_{o}$$

where U is the vector having d components defined as follows:

$${u}^{( k )} = {x}^{( k )} \cdot \frac{{dil}_{k}}{{σ}_{k}}$$

and where the Uᵢ values are obtained in the same manner from the Xᵢ points of the training base. The d components of Uᵢ are obtained from the d components of Xᵢ using the formula:

$${u}_{i}^{( k )} = {x}_{i}^{( k )} \cdot \frac{{dil}_{k}}{{σ}_{k}}$$

The norm used is then the conventional Euclidean norm:

$${‖ U - {U}_{i} ‖}^{2} = {\sum }_{k = 1}^{d} {( {u}^{( k )} - {u}_{i}^{( k )} )}^{2}$$

It should be observed that the coefficients λ are the same regardless of whether the spline is expressed in the form f(X) or h(U).

The idea on which this novel method is based is that of seeking to minimize CVV or GCV over the path by aiming to have the same root mean square sum of the second derivatives of h(U) relative to its various components u^{(k)}, which sum is calculated over all of the points in the training base.

The root mean square sum SQD2U(k) of the second derivative of h(U) relative to its component u^{(k)}, is defined as follows:

$$SQD 2 U ( k ) = \sqrt{\frac{{\sum }_{i = 1}^{n} {( \frac{{\partial }^{2} h ( {U}_{i} )}{\partial {u}^{{( k )}^{2}}} )}^{2}}{n}}$$

with summing being performed over the n points of the training base expressed in U.

A similar quantity can be calculated from the spline f(X) expressed in X:

$$SQD 2 F ( k ) = \sqrt{\frac{{\sum }_{i = 1}^{n} {( \frac{{\partial }^{2} f ( {X}_{i} )}{\partial {x}^{{( k )}^{2}}} )}^{2}}{n}}$$

The relationship between U^{(k)} and X^{(k)} implies that:

$$\frac{{\partial }^{2} h ( {U}_{i} )}{\partial {u}^{{( k )}^{2}}} = \frac{{\partial }^{2} f ( {X}_{i} )}{\partial {x}^{{( k )}^{2}}} * {( \frac{{σ}_{k}}{{dil}_{k}} )}^{2}$$

and thus that:

SQD2U(k)=SQD2F(k)*(σₖ/dilₖ)²

CVV or GCV is minimized over the path seeking to have the same SQD2U(k) for all of the parameters k, while complying with the constraint that the product of all of the scale expansions is equal to 1.

To do this, one proposed method is the following iterative process:

1) Starting from an initial estimate of all of the scale expansions that satisfies the condition:

$${\prod }_{k = 1}^{d} {dil}_{k} = 1$$

If there is no prior knowledge concerning these initial scale expansions, it is generally a good choice to set them all equal to 1.

2) Constructing the multidimensional pseudo-cubic thin plate type spline function with these scale expansions, as explained above.

3) Calculating the d second derivatives of the multidimensional pseudo-cubic thin plate type spline function relative to the d parameters:

$$\frac{{\partial }^{2} f ( {X}_{i} )}{\partial {x}^{{( k )}^{2}}}$$

for k=1 to d

and doing this for each of the n points in the training base (i=1 to n).

4) For each of the d parameters, calculating the root mean square (over all of the points in the training base) of the second derivatives calculated in the preceding step, this root mean square being defined by:

$$SQD 2 F ( k ) = \sqrt{\frac{{\sum }_{i = 1}^{n} {( \frac{{\partial }^{2} f ( {X}_{i} )}{\partial {x}^{{( k )}^{2}}} )}^{2}}{n}}$$

for k=1 to d

5) For this set of scale expansions, calculating either the cross-validation variance CVV, or the generalized cross-validation variance GCV, these two magnitudes being defined above and the way in which they are calculated being described.

6) If not at the first iteration of the iterative process, and if the quantity CVV or GCV is greater than that obtained on the preceding iteration, exiting the iterative process with the preceding values with the scale expansion values of the preceding iteration, and recalculating or restoring the multidimensional pseudo-cubic thin plate type spline function for these scale expansions of the preceding iteration.

7) Calculating the geometric mean C of the above-defined quantities SQD2F(k) weighted by the square of σₖ:

$$C = {( {\prod }_{k = 1}^{d} {σ}_{k}^{2} SQD 2 F ( k ) )}^{1 / d}$$

8) Conceptually, this quantity represents the geometrical mean value of the SQD2U(k).

9) Calculating new scale expansions by a formula such as:

$${new\_ dil}_{k} = {σ}_{k} \sqrt{\frac{SQD 2 F ( k )}{C}}$$

10) Testing the convergence of the iterative process. By way of example, this may be done by testing the maximum of the absolute values of the relative variations between dilₖ and new_dilₖ, i.e. by comparing the following quantity:

$${max}_{k = 1 to n} ( \frac{\vert {dil}_{k} - {new\_ dil}_{k} \vert}{{dil}_{k}} )$$

for example with a predefined convergence threshold. If this quantity is less than the convergence threshold, then convergence is deemed to have been achieved and the iterative process should be exited.

11) Verifying that the iterative process has taken place correctly. This may be done for example by verifying whether the number of iterations is less than some authorized maximum number of iterations, and for example also by verifying whether the ratio:

max(new_dilₖ, k=1 to d)/min(new_dilₖ, k=1 to d)

is less than some other predefined threshold. For example, if one or other of these two conditions is not verified, the iterative process should be exited.

12) Updating the scale expansions, i.e. replacing the dilₖ for k=1 to d with the new_dilₖ, k=1 to d, and returning to step 2 for the next iteration.

The use in step 5 of the above process of the cross-validation variance CVV or of the generalized cross-validation variance GCV corresponds to two possible variances of this implementation of the invention. Using generalized cross-validation variance GCV is generally faster in terms of calculation time, but is sometimes less robust and it does not apply to true interpolators, but only to quasi-interpolators. Using cross-validation variance CVV is more robust and it is recommended whenever extra calculation time can be accepted while conserving a sufficiently large number of portions in the partition, for example more than ten or 15, and using all of these portions when calculating CVV, i.e. P=np in step 5 of the method described for calculating using the “cross-validation” method. The use of CVV instead of GCV is also strongly recommended when using a true interpolator rather than a quasi-interpolator.

When the simulations are weighted, i.e. given weights θᵢ that are not all equal to one another, a recommended variant of the implementation of the invention is to take SQD2F(k) in steps 4 et seq. of the above iterative process as the weighted root mean square (over all of the points of the training base) of the second derivatives calculated in the preceding step, this weighted root mean square being defined by:

$$SQD 2 F ( k ) = \sqrt{\frac{{\sum }_{i = 1}^{n} {{ω}_{i} ( \frac{{\partial }^{2} f ( {X}_{i} )}{\partial {x}^{{( k )}^{2}}} )}^{2}}{{\sum }_{i = 1}^{n} {ω}_{i}}}$$

for k=1 to d

The main advantages provided by the invention are as follows:
The metamodel constructed with the multidimensional pseudo-cubic thin plate type interpolation spline is indeed an interpolator a quasi-interpolator, thereby constituting a considerable advantage compared with polynomials.
Experience shows that the linear system to be solved for the multidimensional pseudo-cubic thin plate type interpolation spline is more stable numerically than is the linear system to be solved for kriging.
There is no need to select the universal kriging trend terms, an operation that is somewhat arbitrary.
The multidimensional pseudo-cubic thin plate type interpolation spline is the single interpolator that minimizes the above-mentioned bending energy.
The multidimensional pseudo-cubic thin plate type interpolation spline is a function that quickly becomes very smooth on going away from the experimental points. On getting further from zones containing experimental points, the spline tends locally towards a hyperplane.
Experience shows that the multidimensional pseudo-cubic thin plate type interpolation spline is better than kriging at finding test points that were not used for building the spline and that lie within the same range of parameters.
The multidimensional pseudo-cubic thin plate type interpolation spline is a little quicker in use than is kriging. The computer needs to calculate square roots instead of exponentials.
There is no constraint on the location of simulations in parameter space [symbol] ^{d}. If a plurality of simulations are at the same location in parameter space [symbol] ^{d}, it suffices to use only one of those simulations (giving the same results, since the software is assumed to be deterministic).
If the software is not completely deterministic and provides responses with a certain amount of variability, it is possible to pass continuously from the interpolation spline to a quasi-interpolation spline by acting on the smoothing parameter ρ.
Is it possible to differentiate the multidimensional pseudo-cubic thin plate type interpolation spline indefinitely almost everywhere, except at the experimental points where it is of class C², i.e. it can be differentiated twice at the experimental points and all partial derivatives of total order less than or equal to 2 are defined and continuous.
The multidimensional pseudo-cubic thin plate type interpolation spline makes it possible to use a number d of parameters that is quite large. Experience shows that there is no harm in this number d of parameters being of the order of 30 or even greater. However it must remain well below the number n of simulations performed.

The invention applies to deterministic simulation methods in all technical and industrial sectors. It can thus be applied to a very wide range of applications, and by way of example, the following may be mentioned: micro-electronics and micro- and nano-technologies (e.g. using technology computer aided design (TCAD) software, or simulation program with integrated circuit emphasis (SPICE) software), mechanical and automobile manufacture, telecommunications, aviation and/or space techniques, building and public works, chemistry, mining, petroleum, and gas extraction, energy, agrifood business, transport, etc. . . .

What is claimed is:

1. A method of interpolating technical data, the method comprising using a computer to construct a metamodel from simulations setting up a training base comprising technical data vectors Xᵢ, for i lying in the range 1 to n, each vector presenting components xᵢ^{(k)}, k varying from 1 to d, wherein the metamodel is a multidimensional pseudo-cubic thin plate type interpolation or quasi-interpolation spline having an analytic function ƒ(X):
$$f ( X ) = {\sum }_{i = 1}^{n} {λ}_{i} {‖ X - {X}_{i} ‖}^{3} + {\sum }_{k = 1}^{d} {α}_{k} {x}^{( k )} + {α}_{o}$$
$${‖ X - {X}_{i} ‖}^{2} = {\sum }_{k = 1}^{d} {{dil}_{k}^{2} ( \frac{{x}^{( k )} - {x}_{i}^{( k )}}{{σ}_{k}} )}^{2}$$
σₖ designating the standard deviation of the k^{th} components Xᵢ^{(k)} of the vectors Xᵢ and dilₖ designating the scale expansion associated with said k^{th} component;
λᵢ and αₖ being the solutions of a symmetrical linear system of dimension (n+d+1)²:
$${\sum }_{j = 1}^{n} {λ}_{j} \cdot {‖ {X}_{j} - {X}_{i} ‖}^{3} + \frac{{λ}_{i}}{{ρω}_{i}} + {\sum }_{k = 1}^{d} {α}_{k} \cdot {x}_{i}^{( k )} + {α}_{o} = {y}_{i}$$
for iε{1, 2, 3, . . . , n}
$${\sum }_{j = 1}^{n} {λ}_{j} \cdot {x}_{j}^{( k )} = 0$$
for kε{1, 2, 3, . . . , d}
$${\sum }_{j = 1}^{n} {λ}_{j} = 0$$
yᵢ designating the response value for the i^{th} simulation for the parameter value Xᵢ, ρ being a smoothing parameter of value that is infinite or a true interpolation, ωᵢ being a weight associated with the i^{th} simulation.

2. A method according to claim 1, wherein in order to determine the scale expansions dilₖ, the following operations are performed:
a) starting from an initial estimate of the d scale expansions dilₖ;
b) randomly or pseudo-randomly partitioning the n simulation results Xᵢ into np disjoint portions (p≧1);
c) iterating over P portions with P≦np;
d) initializing a cross-validation variance to zero;
e) calculating a cross-validation variance from the scale expansion values dilₖ;
f) choosing new scale expansion values that minimize said cross-validation variance obtained during e); and
g) iterating from e) with said new scale expansion values; and
g′) optionally, between e) and f) or between f) and g) testing convergence with a convergence criterion, and if the criterion is satisfied, exiting the iterative process with the current scale expansion values.

3. A method according to claim 2, wherein P<np and in that the portions are selected randomly.

4. A method according to claim 2, wherein, for p varying from 1 to P, e) comprises:
e₁) temporarily eliminating all of the simulation results in said portion;
e₂) determining the function ƒ(X) without these points;
e₃) using the function ƒ(X) solely for recalculating the predicted values over the n_{q} temporarily eliminated points;
e₄) incrementing the cross-validation variance by the sum of the squares of the differences between the predicted values for the temporarily eliminated points and the simulation values for the temporarily eliminated points, this sum being applied to all of the temporarily eliminated points; and
e₅) reintegrating the temporarily eliminated points.

5. A method according to claim 2, wherein the value of np lies in the range 5 to 50.

6. A method according to claim 2, wherein for n_{q} being the number of results in the q^{th} portion, n_{q} is substantially the same in each portion.

7. A method according to claim 6, wherein:
$${\sum }_{q = 1}^{np} {n}_{q} = n$$

8. A method according to claim 7, wherein p=1, and thus np=n, and wherein n_{q}=1, for all q.

9. A method according to claim 1, wherein in order to calculate the scale expansions dilₖ, the method comprises:
a′) starting from an initial estimate of all of the scale expansions, satisfying the condition
$${\prod }_{k = 1}^{d} {dil}_{k} = 1 ,$$
in particular dilₖ=1 for all k;
b′) constructing the multidimensional pseudo-cubic thin plate type spline function ƒ(X) with said scale expansions;
c′) calculating the d second derivatives of the multidimensional pseudo-cubic thin plate type spline function relative to the d parameters:
$$\frac{{\partial }^{2} f ( {X}_{i} )}{\partial {x}^{{( k )}^{2}}}$$
for k=1 to d, and doing this for each of the n points in the training base (i varying from 1 to n);
d′) for each of the d parameters, calculating the root mean square over all of the points in the training base, of the second derivatives calculated in step c′), this root mean square being defined by:
$$SQD 2 F ( k ) = \sqrt{\frac{{\sum }_{i = 1}^{n} {( \frac{{\partial }^{2} f ( {X}_{i} )}{\partial {x}^{{( k )}^{2}}} )}^{2}}{n}}$$
for k lying in the range 1 to d
e′) for this set of scale expansions, calculating a cross-validation variance or a generalized cross-validation variance;
f′) from the second iteration of the iterative process and if the variance is greater than that obtained at the preceding iteration, exiting the iterative process with the scale expansion values of the preceding iteration and retaining the multidimensional pseudo-cubic thin plate type spline function for these scale expansions of the preceding iteration;
g′) calculating the geometrical mean C of the above-defined quantities SQD2F(k) weighted by the square of σₖ:
$$C = {( {\prod }_{k = 1}^{d} {σ}_{k}^{2} SQD 2 F ( k ) )}^{1 / d}$$
this quantity representing the value of the geometric mean of the SQD2U(k);
h′) calculating new scale expansions, in particular using the following formula:
$${new\_ dil}_{k} = {σ}_{k} \sqrt{\frac{SQD 2 F ( k )}{C}}$$
i′) optionally testing the convergence of the iterative process and exiting the iterative process with said new scale expansions obtained in h′); and
j′) updating the scale expansions, i.e. replacing dilₖ for k=1 to d with new_dilₖ for k=1 to d, and returning to step b′) for the next iteration.

10. A method according to claim 9, wherein the convergence test in step i′) provides for testing the maximum of the absolute values of the relative variations between dilₖ and new_dilₖ, i.e. comparing the following quantity:
$${max}_{k = 1 to n} ( \frac{\vert {dil}_{k} - {new\_ dil}_{k} \vert}{{dil}_{k}} )$$
with a predefined convergence threshold, and if the quantity is less than the convergence threshold, exiting the iterative process.

11. A method according to claim 9, wherein between step i′) and j′) it includes a step i′₁) for verifying at least one condition, namely that the number of iterations is less than an authorized maximum number of iterations and/or that the ratio:
max(new_dilₖ, k=1 to d)/min(new_dilₖ, k=1 to d)
is less than a predefined threshold value, and if this condition is not satisfied, exiting the iterative process.

12. A method according to claim 2, wherein the metamodel is a quasi-interpolation metamodel and wherein said cross-validation variance is a generalized variance GCV, with:
$$G C V = \frac{{\sum }_{i = 1}^{n} {{ω}_{i} ( f ( {X}_{i} ) - {y}_{i} )}^{2}}{{( n - trace ( {A}_{ρ} ) )}^{2}} and {\sum }_{i = 1}^{n} {ω}_{i} = n$$
and trace(A_{ρ}) is the trace of the smoothing matrix A_{ρ} that causes the vector Y of the n responses yᵢ to change to the vector F of the n quasi-interpolated values f(Xᵢ):
i.e.:
F=Aᵣ•Y
with
F=(f(X₁), f(X₂), . . . , f(Xᵢ), . . . , f(Xₙ))^{t}
and
Y=(y₁, y₂, . . . , yᵢ, . . . , yₙ)^{t}
the index t designating the transposed matrix, the spline being calculated with a smoothing parameter ρ lying in the range 10⁴ to 10¹⁰.

13. A method according to claim 12, wherein trace(A_{ρ}) is determined by a Monte-Carlo method.
